(19) United States
(12) Patent Application Publication
(10) Pub. No.: US 2004/0175522 A1
(43) Pub. Date: Sep. 9, 2004

(54) Method for producing medical container and medical container

(75) Inventor: Kyousuke Tajima, Tokyo (JP)

Correspondence Address: Jean C. Edwards, DICKINSON WRIGHT PLLC, Suite 800, 1901 L Street, Washington, DC, 20036-3506, US

(73) Assignee: NICCON KOHSAN CO., LTD.

(21) Appl. No.: 10/747,150

(22) Filed: Dec. 30, 2003

(30) Foreign Application Priority Data
Mar. 7, 2003 (JP) JP2003-060827

(51) Int. Cl. B32B 31/00

(52) U.S. Cl. 428/35.7; 156/245; 156/272.8

(57) ABSTRACT

The present invention provides a method for producing a medical container capable of firmly and surely welding, to a sheet or film mainly composed of a thermoplastic resin not limited to those containing polar groups, a port member mainly composed of a thermoplastic resin that is identical with or different from the sheet or film, and a medical container obtained by the production method. This method comprises a first process for molding the sheet or film into a bag shape and temporarily fixing the port member to a prescribed position of the bag-shaped sheet or film; and a second process for irradiating the temporary fixing part 7 of the bag-shaped sheet or film 1 and the port member 5 with laser beam 35 to weld the sheet or film to the port member.

### BACKGROUND OF THE INVENTION

1. Field of the Invention

The present invention relates to a method for producing a medical container and a medical container produced by this production method.

2. Related Art

Medical containers include, for example, a “blood bag” for storing blood or blood components, a “cell culture bag” for storing a biological cell such as bone marrow or lymphocytes, a “urine collecting bag” for storing urine, an “infusion bag” for storing a chemical for drip, an “IVH (intravenous hyperalimentation) bag” for storing nutrients to be directly administered to a central vein, a bag for storing an enteral feeding product, and bags for storing various chemicals.

Extremely high sealing property and toughness are generally required for these medical containers. In a container used for drip or blood transfusion, for example, even a trace leak of air from the container causes a danger of infectious diseases by oxidation of blood or inclusion of bacteria, or affects the quantity of drip or blood transfusion, consequently seriously disturbing medical activities.

Further, the medical containers are frequently placed in an extremely high-temperature condition for sterilizing treatment or the like or in an extremely low-temperature condition for cold or frozen storage, and subjected to a treatment such as vibration or oscillation. However, these containers are not allowed to cause even a slight leak or breakage by such a treatment. Constant shape and inside diameter of a port part is also requested therefor. Even if the shape or inside diameter of the port part is even slightly deformed or distorted, the quantity of drip or the like cannot be kept constant. Accordingly, an extremely high quality specification is requested for such medical containers.

As the blood bag or infusion bag of these medical containers, a glass vessel was often used in the past. However, a so-called soft bag having characteristics such that it is flexible, light and difficult to crack and requires no a ventilation needle when taking out the content was developed, and it has been extensively used.

This soft bag is formed into a container shape by sealing a plastic sheet or film. The sealing was mainly performed by an external heating method for heating a metal mold or the like to seal the plastic sheet or film. However, since the metal mold or the like must be heated until the sheet interface is melted so that the other part of the sheet or a member to be fused is never deformed, the external heating method has a restriction for materials. Further, since the heat generated out of the sheet is transferred through the sheet to give the heat necessary for welding to the sealing face, much time is required for the transfer of the thermal energy necessary for the melting of the sheet interface or the cooling after welding, the production efficiency was poor. The finished shape of the container was not neat although it was not deformed out of shape.

On the contrary to the external heating method, a high-frequency induction-heating sealing method comprises directly working high-frequency energy to molecules constituting a sheet material and directly heating the sheet material by the resulting molecular motion. Therefore, the interface part between sheets to be fused together has a higher temperature than the outside part, consequently providing advantages such as high adhesive strength and a neatly finished shape of the seal. Therefore, when polyvinyl chloride (PVC) or the like was used as the material, the production by the high-frequency induction-heating method was mainly adapted (refer to Japanese Patent Application Laid-Open (Kokai) No. 9-135880).

However, materials that internally generate heat by high-frequency induction heating were limited to those containing polar groups in molecular structure. Namely, when a film or sheet and a port member, which are mainly composed of a polyolefin having no polar substituent such as halogen, are sealed together by high-frequency induction heating, the adhesion between the film or sheet and the port member is insufficient because of the difference in molding temperature between the film or sheet and the port member. Therefore, it causes a problem such as leak in a centrifugal separation test or autoclave resistance test.

On the other hand, the medical containers are not allowed to be easily disposed after use because blood and the like are adhered thereto, and generally subjected to incineration treatment or the like. Accordingly, it has been desired to avoid the use of chlorine-based materials therefor in relation to pollution problems. The polyvinyl chloride was regarded as a problem from the point of safety because it contains a plasticizer, which might be eluted to the internal solution. In an ethylene-vinyl acetate polymer, deacetylation might be caused in molding, resulting in the elution to the internal solution.

In order to solve the above-mentioned problems and utilize the advantages of the high-frequency induction heating sealing method, various attempts have been made, of mixing a polymer material or metallic material which induces internal heating to a material not internally heated by high-frequency to obtain a necessary heating value; and of mixing a metallic powder such as iron powder to polyethylene. It is proposed, for example, to locate a ferromagnetic heating material such as stainless mesh between adhering faces of a polyolefin-based resin and heat the heating material by high-frequency induction heating to fuse it between the adhering faces (refer to Japanese Patent Application Laid-Open No. 63-216570). However, in this method, the heating material such as stainless mesh is left in the medical container, which is improper as medical container.

Further, as a method of attaching a port part to a medical bag, it is disclosed to form the sheet and port of the medical bag by use of a material not heated by high-frequency induction heating, and seal them between two sheets which internally generate heat by high-frequency induction heating (refer to Japanese Patent Application Laid-Open No. 9-2427). In this method, however, although a high-frequency oscillator is used, the sealing mechanism is the external heating method similar to heat-sealing, and the above-mentioned problems could not be solved.

### SUMMARY OF THE INVENTION

In consideration of the above problems, the present invention thus has an object to provide a method for producing a medical container capable of firmly and surely welding a sheet or film mainly composed of a thermoplastic resin not limited to those containing polar groups such as halogen to a hollow port member mainly composed of a thermoplastic resin not limited to those containing polar groups, which is identical with or different from the sheet or film, and a medical container obtained by this production method.

As a result of the studies to solve the above problems, the present inventor has found that a film or sheet mainly composed of a thermoplastic resin containing no polar group is temporarily fixed to a hollow port member mainly composed of a thermoplastic resin containing no polar group, which is identical with or different from the sheet or film, by a welding method such as external heating method or other known methods, and the temporary fixing part of the port member to the film or sheet member is welded by laser, whereby the film or sheet can be firmly sealed to the port member, and a medical container having a high adhesion strength and a neat shape can be provided.

Namely, the present invention involves a method for producing a medical container having a port member installed to a sheet or film consisting of a thermoplastic resin, the port member consisting of a thermoplastic resin identical with or different from the sheet or film, the method comprising a first process for molding the sheet or film in a bag shape and temporarily fixing the port member to a prescribed position of the bag-shaped sheet or film, and a second process for irradiating the temporary fixing part of the port member to the bag-shaped sheet or film to weld the temporary fixing part.

In the production method described above, the second process may comprise rotating the bag-shaped sheet or film with the temporarily fixed port member to radiate the circumferential part of the port member with the laser beam.

In the production method described above, the second process may comprise moving the bag-shaped sheet or film with the temporarily fixed port member on a recessed curved surface at right angles to the laser beam to radiate half of the circumferential part of the port member with the laser beam, then reversing the bag-shaped sheet or film, and moving the bag-shaped sheet or film on the recessed curved surface at right angles to the laser beam to irradiate the other half of the circumferential part of the port member with the laser beam.

In the production method described above, the first process may comprise applying a high-frequency voltage to one metal mold for molding the sheet or film into the bag shape, the other metal mold to be fitted to the one metal mold, and a core metal inserted to the hollow part of the port member.

### BRIEF DESCRIPTION OF THE DRAWINGS

FIG. 1 is a schematic view of a device showing the laser beam welding used in the second process of the present invention;

FIG. 2 is a view showing an example of a medical container produced by the method according to the present invention;

FIG. 3 is a perspective view illustrating a reference example of the metal molds and core metal of a high-frequency welder used in the first process of the present invention; and

FIG. 4 is a view illustrating a test method of adhesive strength.

### BEST MODE FOR CARRYING OUT THE INVENTION

The method for producing a medical container according to the present invention is characterized by comprising a first process for molding a sheet or film into a bag shape by a welding method such as external heating method or other known methods and temporarily fixing the port member to a prescribed position of the bag-shaped sheet or film; and a second process for irradiating the temporary fixing part of the port member to the bag-shaped sheet or film (hereinafter often referred to as a bag-shaped part) with laser beam to weld the temporary fixing part of the port member to the sheet or film. The present invention will be described in detail in reference to the drawings.

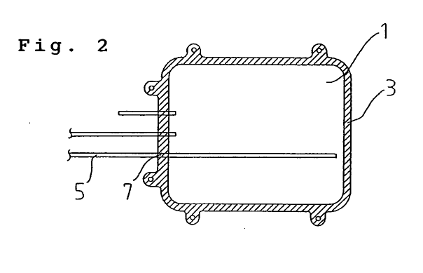

FIG. 2 is a view showing one example of a medical container produced by the production method of the present invention. In FIG. 2, a bag-shaped part 1 is closely adhered by a seal part 3 and formed in a bag shape. The number of port members 5 may be determined according to the purpose of the medical container. The port member 5 is closely adhered to the bag-shaped part in the adhesion part (the above-mentioned temporary fixing part) 7 with the bag-shaped part 1.

<Production Method of Medical Container>

As the method for molding the bag-shaped part and temporarily fixing the port member in the first process of the present invention, a known welding method such as external heating method or induction heating method can be used if it enables the close adhesion of the seal part of the bag-shaped part formed of the same material and having the same molding temperature. Among them, the internal heating method by induction heating is preferred to mold a bag-shaped part having no burr.

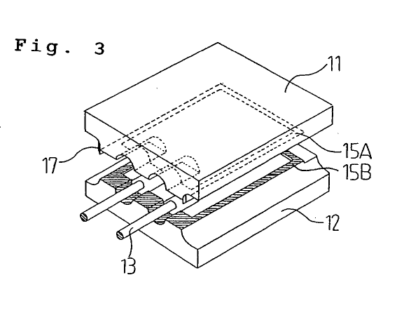

FIG. 3 is a perspective view showing one example of an induction-heating device for executing the molding of the bag-shaped part and the temporary fixation of the port member in the first process of the present invention. In FIG. 3, metal molds 11 and 12 nip the film or sheet. A high-frequency voltage is applied to the electrode 15A of the metal mold 11 and the electrode 15B of the metal mold 12 which are matched to the seal part 3 of FIG. 2 and a core metal 13 inserted to the hollow part of the port member 5, whereby the seal part of the bag-shaped part is closely adhered, and the port member is temporarily fixed in the temporary fixing part 7 with the bag-shaped part 1. A cutter 17 is inserted to the circumference of the electrodes 15A and 15B of the metal molds 11 and 12 to mold the film or sheet into a container of a desired shape.

A commercially available high-frequency oscillator can be used for the oscillation of high-frequency voltage in the present invention. Concretely, a high-frequency welder machine such as KV-5000TU-P, KV-7000TU-P or KV-8000TU-P produced by Seidensha Electronics Co., Ltd. is suitably used.

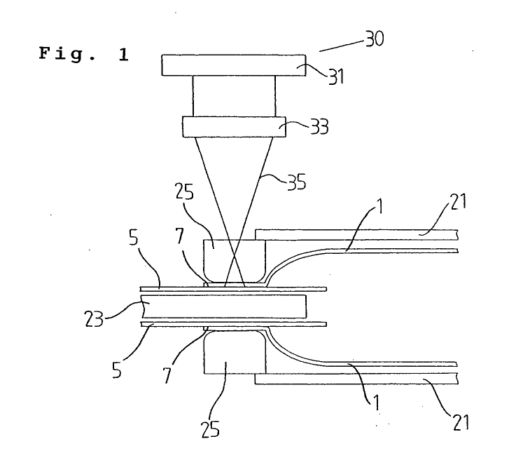

FIG. 1 is a schematic view showing the method for welding the port member 5 to the bag-shaped part 1 in the temporary fixing part 7 in the second process of the present invention. This welding device comprises a bag-shaped part support device 21 rotated or moved in connection to a pressing mechanism described below with the bag-shaped part 1 being installed thereto, a port member protecting bar 23 inserted to the hollow part of the port member 5 to protect the temporary fixing part of the port member 5 from the pressure by the pressing mechanism described below, and the pressing mechanism 25 for pressing the temporary fixing part of the port member to the bag-shaped part from the outside of the bag-shaped part to closely fit the port member to the bag-shaped part. The port member and the bag-shaped part are irradiated with the laser beam 35 emitted from a laser welding mechanism 30 in the state where they are pressed and mutually closely fitted in the temporary fixing part 7 by the pressure of the pressing mechanism 25, and the temporary fixing part is welded.

The laser welding mechanism 30 has, as shown in FIG. 1, a laser oscillator 31 for semiconductor laser or the like and a spot shape adjusting mechanism 33 for adjusting the spot shape of the laser beam 35 from the laser oscillator 31. The spot shape adjusting mechanism 33 is constituted by use of a known lens, for example, a cylindrical lens, so as to be capable of converging the laser beam 35 only to one direction and imaging it in a long elliptic shape.

As the laser beam of the laser welding mechanism 30, semiconductor laser or gas laser such as carbon dioxide gas laser is suitably used. Among them, semiconductor laser is particularly suitable because of its property of being easily transmitted by a transparent body or a translucent body. The output of the laser oscillator in the present invention is preferably set within the range of 1 to 1000 W. The wavelength of the laser beam is preferably set to 500-1300 nm, more preferably 700-900 nm, and particularly preferably 750-850 nm.

The distance between the spot shape adjusting mechanism 33 for laser beam and the temporary fixing part (hereinafter referred to as a work distance) is preferably set to 30-400 mm, more preferably 50-300 mm, and particularly preferably 80-250 mm.

In the irradiation of the temporary fixing part to be welded, a certain distance from the focus of the laser beam must be ensured in order to image the laser beam in a long elliptic shape. The ratio h/ho of the distance h between the focusing lens to the focus to the distance ho between the focus and the temporary fixing part (hereinafter referred to as h/ho ratio) is preferably set to 30-400, more preferably 50-300, and particularly preferably 80-250.

In the irradiation of the temporary fixing part with the laser beam, the entire irradiation of the temporary fixing part is preferable from the viewpoint of firm welding although a high adhesive effect can be obtained by the partial irradiation of the temporary fixing part in a ring shape.

As the laser oscillator 31 used in the present invention, a commercially available laser oscillator can be used. Concretely, a laser oscillator LD100 produced by Seidensha Electronics Co., Ltd. or the like is suitably used.

The laser oscillator 31 of the laser welding mechanism 30 is arranged on the temporary fixing part 7, and the laser beam 35 is transmitted by the pressing mechanism 25 and radiated to the temporary fixing part 7 in a long elliptic shape having a long axis parallel to the port member protecting bar 23. The bag-shaped part support device 21 has a mechanism for uniformly irradiating the circumference of the port member 5 in the temporary fixing part with the laser beam 35 while constantly keeping the distance between the spot shape adjusting mechanism 33 and the circumference of the port member 5 in the temporary fixing part 7. Concretely, a mechanism rotated around the port member protecting bar 23 integrally with the pressing mechanism 25 connected to the bag-shaped part support device 21 or a mechanism moved on the recessed curved surface at right angles to the laser beam 35 is preferably used. Particularly, the rotating mechanism is preferable. In the mechanism moving on the recessed curved surface at right angles to the laser beam 35, the laser oscillator 31 and the spot shape adjusting mechanism 33 are preferably of movable type. The moving speed of the bag-shaped part support device 21 is preferably set so that the irradiation time around the circumference of the port member is 5-25 sec, more preferably 8-18 sec.

The circumferential part of the port member is irradiated with the laser beam, whereby the contact faces (the above-mentioned temporary fixing part) of the port member and the bag-shaped part are mutually welded, and a firm and stable welding can be attained.

The bag-shaped part and the port member must be transparent or translucent bodies in order to transmit the laser beam. The part to be welded to the bag-shaped member of the port member preferably has a light shielding rate of 50% or more, more preferably 80% or more in order to convert the optical energy of the laser beam to heat. The light-shielding rate referred herein means the light-shielding rate with a standard light source A regulated in JIS Z 8720. Concretely, black color having a high absorptivity of laser beam or a color close thereto is preferred, but carbon is not preferred because it is easy to carbonize.

As the pressing mechanism 25, which presses the bag-shaped part on the outside of the temporary fixing part to closely fit the port member to the bag-shaped part in the temporary fixing part, either type of mechanical press mechanism or air pressurizing mechanism can be adapted. Particularly, a mechanism for injecting air to a balloon-like elastic body to pressurize the outer surface of the bag-shaped part is preferred from the point of enhancing the close fitting effect between the port member and the bag-shaped member. The pressing mechanism must be formed of a transparent body or translucent body in order to transmit the laser beam.

After the welding is ended, the port member protecting bar 25 is removed from the temporary fixing part of the bag-shaped part, the bag-shaped part support mechanism 23 is carried by a bag-shaped part carrying device not shown, and the weld part is naturally cooled in the meantime. Integrating a forced cooling device such as cooling fan may forcedly cool the weld part.

<Sheet or Film>

The thermoplastic resin used in the present invention need not be particularly limited. Concretely, it is preferably a monopolymer and/or copolymer and/or polymer blend containing at least one selected from the group consisting of polyethylene, polypropylene, polybutene, polybutadiene, polyisoprene, poly-4-methylpenten-1,polystyrene, polyvinyl acetate, polymethyl methacrylate, polyethyl methacrylate, polyacrylic acid, cyclic polyolefin, polyacrylonitrile, polyamide (nylon), polyester, polyurethane, polycarbonate, polyimide, and polyphenylene sulfide.

Examples of the copolymer include an ethylene-a-olefin copolymer including ethylene-propylene copolymer, ethylene-butene copolymer, ethylene-hexene copolymer and ethylene-octene copolymer, an ethylene-vinyl acetate copolymer, a saponified product of ethylene-vinyl acetate copolymer, an ethylene-acrylic acid copolymer, an ethylene-ethyl acrylate copolymer, an ethylene-methyl methacrylate copolymer, an ethylene-maleic anhydride copolymer, an ionomer, a block copolymer consisting of a part mainly composed of styrene and/or ethylene and a part consisting of butadiene and/or isoprene and/or hydrogenated products thereof, a polyamide (nylon)-polyether block copolymer, a polyester-polyether block copolymer, a polyester-polyester block copolymer, and a polyether-based, polyester-based, or polycarbonate-based urethane elastomer.

As other examples of the thermoplastic resin containing no halogen element used in the present invention, a blend of thermoplastic elastomer and polyolefin is preferably used. Concrete examples of the polyethylene include low-density polyethylene (LDPE), high-density polyethylene (HDPE), and linear low-density polyethylene (LLDPE) . Concrete examples of the polypropylene include homopolymer, random copolymer, and block copolymer thereof, isotactic polypropylene, atactic polypropylene, and syndiotactic polypropylene.

As the thermoplastic resins that are the raw materials of the sheet, film, and port member used in the present invention, thermoplastic resins comprising the above-mentioned copolymer consisting of a part mainly composed of styrene and/or ethylene and a part consisting of butadiene and/or isoprene and/or hydrogenated products thereof and a polymer blend of polyethylene and/or polypropylene and/or polybutene are preferably used. These are described in Japanese Patent Application Laid-Open Nos. 54-88950 and 4-314452, and the like, and a transparent, flexible, and autoclave-sterilizable medical bag can be provided.

The sheet or film used in the present invention may have a single-layer or multi-layer structure. The thickness of the sheet or film is not particularly limited. However, the thickness is desirably set to 0.05 mm or more and 2 mm or less. When it is less than 0.05 mm, the strength as the medical container cannot be retained, and when it exceeds 2 mm, a problem is caused in flexibility.

In a sheet having a multi-layer structure, a material that easily internally generates heat when applying a high-frequency to the inner surface, or conventional polyamide, polyester and polyurethane that are materials capable of being high-frequency sealed may be used, and the use thereof is often preferable. The thickness of such a material that is heated by high-frequency sealing is desirably set to 2% or more and 95% or less of the whole thickness. The production process of the sheet or film of multi-layer structure used in the present invention is not particularly limited. For example, any of dry lamination, wet lamination and co-extrusion molding and other methods can be adapted. The sheet or film used in the present invention is desirably formed of a sheet of multi-layer structure having the innermost layer of the medical container consisting of a thermoplastic elastomer selected from polyamide elastomer, polyester elastomer, and polyurethane elastomer.

As the polyamide elastomer, a multi-block copolymer using a crystalline polyamide having a high melting temperature as hard segment and an amorphous polyether or polyester having a low glass transition temperature as soft segment, or a so-called polyether amide (called also polyether ester amide) or polyester amide is preferably used.

As the polyester elastomer, a polyester-polyether type using aromatic polyester, for example, a polycondensate of 1,4-butanediol and terephthalic acid as hard segment and a polytetramethylene glycol of aliphatic polyester as soft segment, or a polyester-polyester type using aliphatic polyester as soft segment is preferably used.

As the polyurethane elastomer, a one using 4,4′-diphenylmethane diisocyanate (MDI), 1,4-butandiol (BD) as chain extending agent, and polyol or polyester as soft segment is preferably used.

<Others>

The environment, atmosphere and the like in the production of a medical container by the method of the present invention are not particularly limited. However, the laser welding is preferably carried out, for example, in a clean room or clean booth of Class 100-10000 based on the standards of National Aeronautics and Space Administration (NASA).

The adhesion part of the medical container produced by the method of the present invention preferably has an adhesive strength of 0.1 kgf/cm2 or more, more preferably 0.8 kgf/cm2, in the mutual adhesion of sheets or films or in the adhesion between the sheet or film and the port member. This adhesive strength is the value to which attention must be paid particularly in a medical container, which is subjected to autoclave sterilization with an infusion solution, or chemical or centrifugal separation with blood. When the adhesive strength is less than 0.1 kgf/cm2, the adhesion part might be peeled in the autoclave sterilization with the infusion solution or chemical or the centrifugal separation with the blood.

The medical container of the present invention is not particularly limited when it is used in medical fields, and neither is the kind, shape, size, color, presence of print or the like. Concrete examples of the medical container of the present invention include, for example, a “blood bag” for storing blood and blood components, a “cell culture bag” for storing a biological cell such as bone marrow or lymphocytes, a “urine collecting bag” for storing urine, an “infusion bag” for storing a liquid medicine for drip, an “IVH bag” for storing nutrients to be directly administered to a central vein, a bag for storing an enteral feeding product, and a bag for storing various liquid medicines.

The method of filling the content to the medical container of the present invention is not particularly limited. Concretely, the content is filled, for example, through the hollow part of the port member, the internal air is removed as occasion demands, and a rubber plug is fitted to the hollow part at the tip of the port member. Preferably, a plastic film is further stuck to the upper surface of the rubber plug, or a cover is put thereon in order to keep the biological cleanness. The rubber plug is used to mix a chemical such as antibiotic agent or insulin according to patients into the container when the content is an infusion solution. Thereafter, the container is generally sterilized at 121° C. for 20 min in an autoclave.

In the “blood bag”, “cell culture bag”, or “urine collecting bag”, the container is often commercially available without being filled with the content.

### EXAMPLES

The present invention is concretely described according to examples. The present invention is never limited by these examples.

### Example 1

Using a polyolefin mainly composed of polypropylene (trade name: HiFAS-H, transparent 200μ, produced by Okura Industrial Co., Ltd.) as raw material, a sheet about 0.20 mm thick was obtained by use of an extrusion testing machine (Labo Plastomill, produced by Toyo Seiki Seisaku-sho, Ltd.) with a 120-mm T die attached thereto.

Using. a polyolefin mainly composed of polypropylene (trade name; Ultracene 751, produced by Toso Company, Limited) as raw material, a port member having a hollow part having an inside diameter of 6 mm, a thickness of 1 mm and an outer diameter of 8 mm was molded by use of an extrusion molding machine (FS80S12ASE, produced by Nissei Plastic Industrial Co., Ltd.). The circumferential surface of the welding scheduled part with the sheet of the port member was colored black. The light- shielding ratio with a standard light source A regulated in JIS Z 8720 was 98%.

The above sheet and port member were installed to the metal molds shown in FIG. 3, and high-frequency sealed into a bag shape by use of a high-frequency welder machine KV-5000TU-P produced by Seidensha Electronics Co., Ltd. to produce a bag-shaped part 1 with the port member temporarily fixed thereto. The sealing width of the temporary fixing part 7 of the port member 5 to the bag-shaped part 1 was set to 10 mm, and the sealing width of the seal part 3 of the bag-shaped part was set to 5 mm.

The sealing was carried out under conditions of oscillating frequency 40.46 MHz±0.599%, applied voltage 200V, output 7 KW, metal mold temperature 90±5° C., applying time 5 sec, and cooling time 5 sec.

The one with the port member temporarily fixed to the bag-shaped part produced by the above work was taken as a medical container of Comparative Example 1.

In the thus-obtained bag-shaped part with the temporarily fixed port member, the sheet and the port member in the temporary fixing part 7 were welded together by use of the welding device shown in FIG. 1. The bag-shaped part 1 was installed to the bag-shaped part support device 21, the port member protecting bar 23 was inserted to the hollow part of the port member 5, and the pressing mechanism 25 was then operated to press the temporary fixing part 7 of the bag-shaped part from outside, so that the port member was closely fitted to the bag-shaped part. In the mutually closely fitted state, the port member and the bag-shaped part in the temporary fixing part 7 were irradiated with the laser beam 35 from the laser welding mechanism 30 under the following irradiation conditions while rotating the bag-shaped part support device 22, and welded together, whereby a medical container of Example 1 was obtained. The irradiation conditions were set to voltage 200V, laser beam output 100W, wavelength 808 nm±3 nm, work distance 200 mm, h/ho ratio 99, spot long diameter 2 mm, irradiation time 10 sec, and cooling time 10 sec.

### Example 2

Using the same sheet and port member as in Example 1, a medical container of Example 2 was obtained in the same manner as Example 1, except setting the irradiation conditions of laser beam to voltage 200V, laser beam output 30 W, wavelength 808 mm±3 mm, work distance 100 mm, h/ho ratio 99, spot long diameter 1 mm, irradiation time 15 sec, and cooling time 15 sec.

### Example 3

A medical container of Example 3 was obtained in the same manner as Example 1, except using a polyolefin mainly composed of polypropylene (trade name: TP200H, produced by Taiyo Plastics) instead of the polyolefin used in Example 1 (trade name: HiFAS-H transparent 200μ, produced by Okura Industrial Co., Ltd.).

### Example 4

A medical container of Example 4 was obtained in the same manner as Example 2, except using the same material as in Example 3.

### Comparative Example 1

Using the same sheet and port member as in Example 1 and the same metal mold and high-frequency welder machine as in Example 1, welding was performed under the same sealing conditions as in Example 1, whereby a medical container of Comparative Example 1 was obtained. Namely, the container with the temporarily fixed port member of Example 1 was provided as a test product of Comparative Example 1.

### Comparative Example 2

A medical container of Comparative Example 2 was obtained in the same manner as Comparative Example 1, except using the same sheet and port member as in Example 3.

<Evaluation of Adhesive Strength>

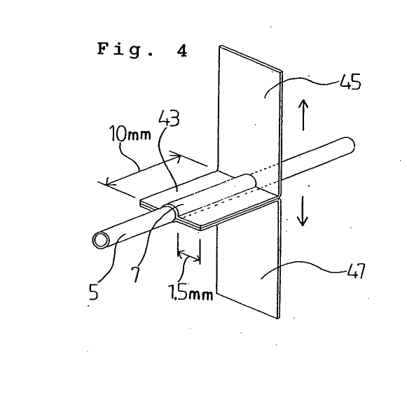

Specimens used in the adhesive strength test for the adhesion part (the above-mentioned temporary fixing part 7)-of the bag-shaped part and the port member in the present invention were shown in FIG. 4. The temporary fixing part 7 (length 10 mm) of the bag-shaped part and the port member was entirely welded by laser beam followed by cooling. The sheet including the adhesion part was then cut in parallel to the port member 5 so that the width of the residual piece 43 of the sheet from the edges of the port member was 1.5 mm on both sides of the port member, respectively, and the cut piece was further cut out so that sheet pieces 45 and 47 of the bag-shaped part have 30 mm to prepare a specimen for tensile strength test. The space of chucks of a tensile tester (Autograph produced by Shimadzu Corporation) was set to 20 mm to chuck the sheet pieces 45 and 47, and the pieces were pulled in the arrowed directions at a pulling rate of 200 mm/min (23° C.) until they were ruptured. The value at that time was divided by 2 followed by conversion to a value per cm of the cross width of the sheet pieces 45 and 47, the resulting value was taken as the adhesive strengths, and the average value of five samples was determined in each of Examples and Comparative Examples. The evaluation result is shown in Table 1.

<Evaluation of Leak>

Bovine blood of 200 ml was put in the medical container of the present invention, the hollow part of the port member 5 was closed, and centrifugal separation was performed at 3000 rpm for 10 min (centrifugal separation test). Thereafter, the medical container was allowed to stand on white gauze for 1 hr, and the leak of the content blood was determined according to the coloring of the gauze. The evaluation result of 20 samples is shown in Table 1.

TABLE 1

| | Adhesive Strength | Number of Leaks |
|---|---|---|
| | (kg/cm²) | (/20) |
| Example 1 | 5.3 | 0 |
| Example 2 | 5.5 | 1 |
| Example 3 | 5.5 | 0 |
| Example 4 | 5.4 | 0 |
| Comparative Example 1 | 4.8 | 10 |
| Comparative Example 2 | 4.7 | 11 |

As is apparent from Table 1, the bag-shaped part and port member constituting the medical container of the present invention were firmly adhered together with a satisfactory adhesive state in both Examples and Comparative Examples, but the strength in each Example was higher than Comparative Examples.

In the evaluation of leak, although a trace coloring was observed in one piece of gauze in Example 2 and determined as leak, no leak was observed in other Examples, and a satisfactory result was obtained. On the contrary, 10 leaks and 11 leaks were observed in Comparative Example 1 and Comparative Example 2, respectively. Namely, the leak phenomenon was observed in nearly half of the specimens, and the adhered state could not be said to be perfect.

<Evaluation of Apparent Shape>

The degree of welding was examined by visually confirming the appearance. The finish in each Example had a neat appearance without fusion unevenness on the surface of the port member. In each Comparative Example, fusion unevenness was observed in the surface of the port member, and the finish could not be said to be satisfactory.

It will be obvious to those having skill in the art that many changes may be made in the above-described details of the preferred embodiments of the present invention. The scope of the present invention, therefore, should be determined by the following claims.

1. A method for producing a medical container having a port member installed to a sheet or film consisting of a thermoplastic resin, the port member consisting of a thermoplastic resin identical with or different from the sheet or film, the method comprising:
a first process for molding the sheet or film into a bag shape and temporarily fixing the port member to a prescribed position of the bag-shaped sheet or film; and
a second process for irradiating the temporary fixing part of the bag-shaped sheet or film and the port member with laser beam to weld the temporary fixing part.

2. The method for producing a medical container according to claim 1, wherein the second process comprises rotating the bag-shaped sheet or film with the temporarily fixed port member to irradiate the circumferential part of the port member with the laser beam.

3. The method for producing a medical container according to claim 1, wherein the second process comprises moving the bag-shaped sheet or film with the temporarily fixed port member on a recessed curved surface at right angles to the laser beam to irradiate half of the circumferential part of the port member with the laser beam, then reversing the bag-shaped sheet or film, and moving the bag-shaped sheet or film on the recessed curved surface at right angles to the laser beam to irradiate the other half of the circumferential part of the port member with the laser beam.

4. The method for producing a medical container according to claim 1, wherein the first process comprises applying a high-frequency voltage to one metal mold for molding the sheet or film into the bag shape, the other metal mold matched to the one metal mold, and a core metal inserted to the hollow part of the port member.

5. The method for producing a medical container according to claim 2, wherein the first process comprises applying a high-frequency voltage to one metal mold for molding the sheet or film into the bag shape, the other metal mold matched to the one metal mold, and a core metal inserted to the hollow part of the port member.

6. The method for producing a medical container according to claim 3, wherein the first process comprises applying a high-frequency voltage to one metal mold for molding the sheet or film into the bag shape, the other metal mold matched to the one metal mold, and a core metal inserted to the hollow part of the port member.

7. The method for producing a medical container according to claim 5, wherein the laser beam is by semiconductor laser.

8. The method for producing a medical container according to claim 6, wherein the laser beam is by semiconductor laser.

9. The method for producing a medical container according to claim 7, wherein the sheet or film has a single-layer or multi-layer structure.

10. The method for producing a medical container according to claim 8, wherein the sheet or film has a single-layer or multi-layer structure.

11. The method for producing a medical container according to claim 9, wherein the thermoplastic resin is a thermoplastic resin free from polar substituent.

12. The method for producing a medical container according to claim 10, wherein the thermoplastic resin is a thermoplastic resin free from polar substituent.

13. The method for producing a medical container according to claim 9, wherein the thermoplastic resin is a monopolymer and/or copolymer containing at least one of the group consisting of polyethylene, polypropylene, polybutene, polybutadiene, polyisoprene, poly-4-methylpenten-1, polystyrene, polyvinyl acetate, polymethyl methacrylate, polyethyl methacrylate, polyacrylic acid, cyclic polyolefin, polyacrylonitrile, polyamide (nylon), polyester, polyurethane, polycarbonate, polyimide, and polyphenylenesulfide.

14. The method for producing a medical container according to claim 10, wherein the thermoplastic resin is a monopolymer and/or copolymer containing at least one of the group consisting of polyethylene, polypropylene, polybutene, polybutadiene, polyisoprene, poly-4-methylpenten-1, polystyrene, polyvinyl acetate, polymethyl methacrylate, polyethyl methacrylate, polyacrylic acid, cyclic polyolefin, polyacrylonitrile, polyamide (nylon), polyester, polyurethane, polycarbonate, polyimide, and polyphenylenesulfide.

15. The method for producing a medical container according to claim 13, wherein the medical container is at least one of a bag for storing blood and blood components, a bag for storing a body fluid such as bone marrow, lymphocytes or urine, an infusion bag, a bag for storing nutrients to be directly administered to a central vein, a bag for storing an enteral feeding product, and various bags for storing various chemicals.

16. The method for producing a medical container according to claim 14, wherein the medical container is at least one of a bag for storing blood and blood components, a bag for storing a body fluid such as bone marrow, lymphocytes, or urine, an infusion bag, a bag for storing nutrients to be directly administered to a central vein, a bag for storing an enteral feeding product, and various bags for storing various chemicals.

17. A medical container produced by the production method according to claim 1.

18. A medical container produced by the production method according to claim 4.

19. A medical container produced by the production method according to claim 13.

20. A medical container produced by the production method according to claim 14.
